(19) United States
(12) Patent Application Publication
(10) Pub. No.: US 2008/0188968 A1
(43) Pub. Date: Aug. 7, 2008

(54) SOUND DATA PROCESSING APPARATUS

(75) Inventor: Kenichi KIYOZAKI, Gifu (JP)

Correspondence Address: CANTOR COLBURN, LLP, 20 Church Street, 22nd Floor, Hartford, CT, 06103, US

(73) Assignees: SANYO ELECTRIC CO., LTD., Osaka (JP); SANYO SEMICONDUCTOR CO., LTD., Gunma (JP)

(21) Appl. No.: 12/026,688

(22) Filed: Feb. 6, 2008

(30) Foreign Application Priority Data
Feb. 6, 2007 (JP) JP2007-026768

(51) Int. Cl. G06F 17/00

(52) U.S. Cl. 700/94

(57) ABSTRACT

A sound data processing apparatus includes a decoder for performing decoding processing of sound data, an interface unit connected to an external memory, a data transfer control unit for reading the sound data from the external memory mounted on the interface unit to transfer the read sound data to the decoder, and a central processing unit for controlling the processing of the decoder, the interface unit, and the data transfer control unit. The power consumption of electronic equipment including the sound data processing apparatus is thereby decreased.

### CROSS-REFERENCE TO RELATED APPLICATION

The entire disclosure of Japanese Patent Application No. 2007-026768 including the specification, claims, drawings, and abstract is incorporated herein by references.

### BACKGROUND OF THE INVENTION

1. Field of the Invention

The present invention relates to a sound data processing apparatus for processing sound data.

2. Description of the Related Art

In recent years, a sound data processing apparatus for reading sound data stored in an external memory to perform decoding processing and the like on the read sound data by connecting an external memory, such as a flash memory, to the apparatus has been widely used.

The configuration of a background art sound data processing apparatus 100 is shown in FIG. 3. The sound data processing apparatus 100 includes a central processing unit (CPU) 10, a decoder 12, and an interface unit (IF unit) 14. An external memory 102, such as a flash memory, is recognized by the CPU 10 when the external memory 102 is connected to the IF unit 14. When the CPU 10 perceives the external memory 102, the CPU 10 first reads the sound data stored in the external memory 102 through the IF unit 14 in accordance with a user instruction or the like, and transfers the read sound data to the decoder 12 at predetermined timing. The decoder 12 decodes the sound data transferred from the external memory 102 in accordance with a predetermined format, and outputs the decoded sound data as an audio output.

Moreover, a technique of providing an audio system compatible with a multi-codec coping with a plurality of audio codecs has been disclosed. The technique judges whether an audio codec program stored in a RAM incorporated in a digital signal processing unit (DSP) is compatible with music information to be decoded by the digital signal processing unit or not with a CPU, and changes the processing of the program to conform with any recognized compatibility.

Now, the sound data processing apparatus 100 is frequently mounted on a portable compressed music reproducing apparatus. In such a case, the CPU 10 sometimes must perform many processing steps, such as the acceptance processing of key input from a user and the control processing of a display apparatus, and the CPU 10 is not specialized for transfer of sound data.

It is thereupon necessary to put the entire multifunctional CPU 10 in the active state thereof even at the time of simply performing the reading of sound data from the external memory 102 and the transfer of the read sound data to the decoder 12, and there is a problem that overall power consumption of the entire apparatus is increased.

### SUMMARY OF THE INVENTION

An aspect of the present invention is a sound data processing apparatus composed of a decoder for performing the decoding processing of sound data, an interface unit connected with an external memory, a data transfer control unit for reading the sound data from the external memory connected to the interface unit to transfer the read sound data to the decoder, and a central processing unit for controlling the processing of the decoder, the interface unit, and the data transfer control unit.

### BRIEF DESCRIPTION OF THE DRAWINGS

Preferred embodiments of the present invention will be described in detail based on the following drawings, wherein:

FIG. 1 is a block diagram showing the configuration of a sound data processing apparatus of an embodiment of the present invention;

FIG. 2 is a flowchart showing a processing method of the sound data processing apparatus of the embodiment of the present invention; and

FIG. 3 is a block diagram showing the configuration of a background art sound data processing apparatus.

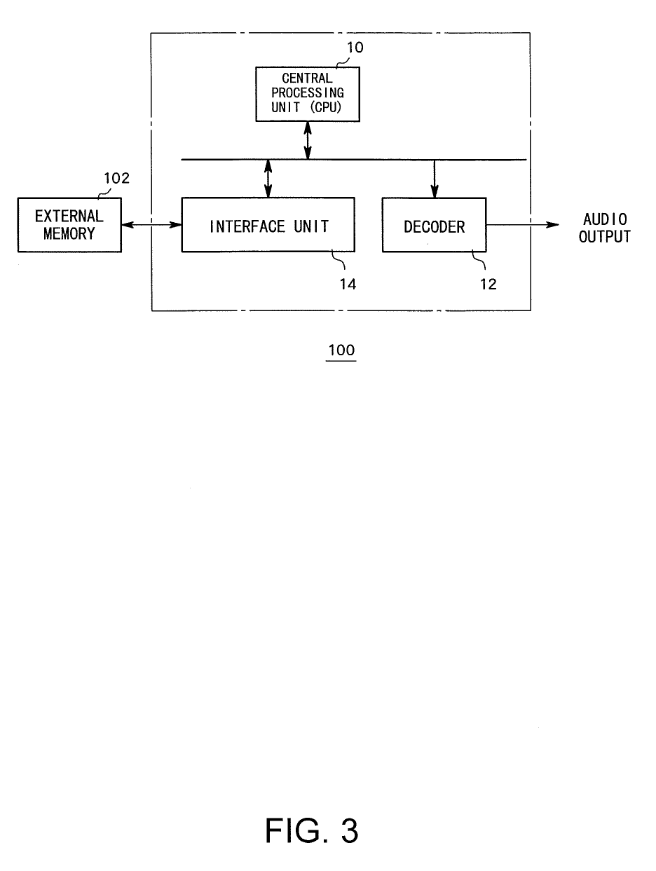

### DESCRIPTION OF PREFERRED EMBODIMENTS

### [Configuration of Apparatus]

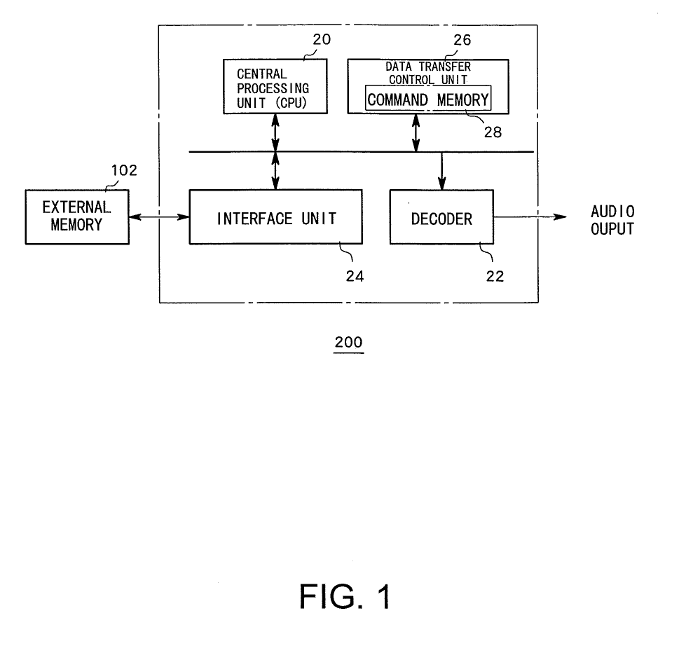

A sound data processing apparatus 200 of an embodiment of the present invention is composed of a central processing unit (CPU) 20, a decoder 22, an interface unit (IF unit) 24, and a data transfer control unit 26, as shown in FIG. 1.

The CPU 20, the decoder 22, the IF unit 24, and the data transfer control unit 26 are connected with one another so as to be mutually capable of performing the transmission and reception of data through a bus. The sound data processing apparatus 200 is connected to an external memory 102 through the IF unit 24. A memory card, such as a flash memory, can be used as the external memory 102.

The CPU 20 is a semiconductor device to synthetically control electronic equipment including the sound data processing apparatus 200. As the electronic equipment to be mounted with the sound data processing apparatus 200, for example, a compressed music reproducing apparatus, a cellular phone equipped with wireless communication means, and a personal digital assistant (PDA) for performing data management can be cited. The CPU 20 can be configured as, for example, an application specific integrated circuit (ASIC). The CPU 20 controls the electronic equipment by executing a program registered in an incorporated memory.

For example, if the sound data processing apparatus 200 is the compressed music reproducing apparatus, the CPU 20 accepts the key input from a user using an operation unit (not shown) connected to the bus, and controls the reproduction conditions of music according to the key input, and perform the control of making a display apparatus (not shown) display the result of the control of the reproduction conditions.

The decoder 22 takes in the sound data subjected to coding processing and compressing processing in a predetermined format from the bus, and performs the expanding processing and decoding processing of the sound data in accordance with the format. As the coding system of sound data, for example, WMA, AMR, Div X, G.723, MP3, and AAC can be cited.

The IF unit 24 is composed of an adapter unit for mounting the external memory 102 thereon, a connector unit for being electrically connected with an external terminal of the external memory 102, and a data processing unit for performing the reading and writing of data with the external memory 102.

The adapter unit of the IF unit 24 has an insertion space adjusted to the external form of the external memory 102. The connector unit of the IF unit 24 contacts an electrode provided to the external memory 102 when the external memory 102 is mounted on the adapter unit, and thereby the connector unit electrically connects the internal electric circuits of the external memory 102 with the data processing unit of the IF unit 24.

If the external memory 102 is a memory card, for example, a control program or a control logic circuit in the data processing unit of the IF unit 24 interprets an instruction, such as data reading, from the CPU 20 or the data transfer control unit 26 through a register in conformity with a PC card ATA standard interface, and converts the instruction into a command according to the type of the external memory 102 mounted on the adapter unit. The command is transmitted to the internal electric circuits of the external memory 102, and the data (sound data) stored in the external memory 102 is read.

The data transfer control unit 26 is a control circuit for performing direct memory access (DMA) transfer. It is possible to directly read sound data from the external memory 102 without executing any operation processing of the CPU 20 in data reading using the data transfer control unit 26.

The data transfer control unit 26 is, preferably provided with a command memory 28 for holding a plurality of control methods (hereinafter referred to as commands) of data transfer in order that the data transfer control unit 26 may have a versatile function pertaining to data transfer. The command memory 28 can be composed of a plurality of registers according to the number of commands to be stored, and the commands are set by the CPU 20. The CPU 20 transmits only an instruction for starting the control of data transfer in conformity with the command to the data transfer control unit 26, and the data transfer control unit 26 reads commands from the command memory 28 in order to execute the read commands in accordance with the instruction. By the provision of the command memory in the data transfer control unit 26, the data transfer control unit 26 capable of being adapted to various kinds of data transfer can be realized without increasing the circuit size thereof.

In the data transfer using the CPU 20, the CPU 20 controls the transfer of sound data by outputting an instruction to perform three steps of data reading instruction to the IF unit 24, data reading from the external memory 102, and data transfer from the IF unit 24 to the decoder 22.

On the other hand, during data transfer using the data transfer control unit 26, when a transfer instruction has been once issued from the CPU 20 to the data transfer control unit 26, the data transfer control unit 26 controls the transfer of sound data by outputting an instruction to perform the three steps of data reading instruction to the IF unit 24, data reading from the external memory 102, and data transfer from the IF unit 24 to the decoder 22. The data transfer control unit 26 monitors the data transfer processing from time to time, and outputs a signal indicating the completion of the data transfer processing to the CPU 20 at the time point when the data transfer of a group of sound data (for example, the sound data for a piece of music) has been completed.

### [Control Method]

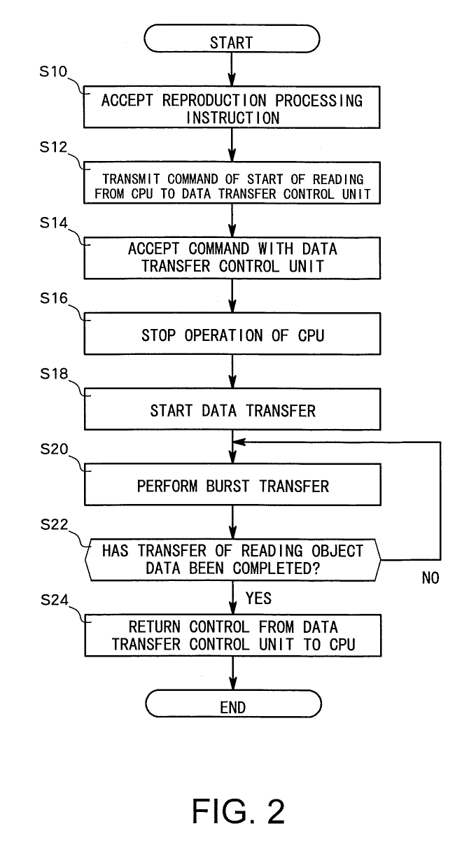

Next, the control of the sound data processing apparatus 200 of the present embodiment will be described with reference to the flowchart shown in FIG. 2. In the following description, it is supposed that the external memory 102 storing reproduction object sound data is previously mounted on the IF unit 24.

At Step S10, a reproduction processing instruction of sound data is accepted. The CPU 20 accepts from a user interface (not shown), such as the operation unit, a sound data reproduction processing instruction and specification information for specifying sound data as an object to be read. As the specification information, a file name list of the sound data that has been previously read from the external memory 102 mounted on the IF unit 24 may be displayed on the display unit (not shown) of the user interface for allowing a user to select the name of a reproduction object file from the list. When the CPU 20 accepts the sound data reproduction processing instruction and the specification information, the CPU 20 shifts the processing thereof to Step S12.

At Step S12, a command of instructing the data transfer control unit 26 to read sound data is transmitted from the CPU 20 to the data transfer control unit 26. When the CPU 20 accepts the sound data reproduction processing instruction at Step S10, the CPU 20 transmits the command of starting the reading processing to the data transfer control unit 26 together with the specification information. At Step S14, the data transfer control unit 26 accepts the command from the CPU 20.

At Step S16, the supply of clock signals to the CPU 20 is stopped to stop the operation of the CPU 20. At this time, the CPU 20 continues the stopping of the operation thereof unless an interrupt signal is input. At Step S18, the data transfer control unit 26 transmits an instruction to each of the IF unit 24 and the decoder 22, and thereby the sound data stored in the external memory 102 is read. Then, the decoding processing is performed, and the processing of outputting an audio signal is started.

At Step S20, the data transfer control unit 26 continues to perform the control of reading sound data from the external memory 102 through the IF unit 24 every predetermined number of bytes to transfer the read sound data from the memory space obtained at Step S18 to the decoder 22 without the care of the CPU 20. The decoder 22 sequentially decodes the data input from the data transfer control unit 26 to output the decoded data as an audio signal.

At Step S22, it is judged whether or not the entire sound data specified as a reading object has been read. The data transfer control unit 26 judges whether the reading of the entire sound data stored in the memory space obtained at Step S18 has been completed or not. If the reading has been completed, then the data transfer control unit 26 shifts the processing thereof to Step S24. If the reading has not been completed, then the data transfer control unit 26 returns the processing to Step S20.

At Step S24, the processing is returned from the data transfer control unit 26 to the CPU 20. The data transfer control unit 26 transmits a completion signal indicating the completion of the burst transfer to the CPU 20. The CPU 20 receives the completion signal, and the data transfer processing is completed.

As described above, in the present embodiment, the data transfer processing of the sound data processing apparatus 200 is performed substantially without the participation of the CPU 20. Consequently, the processing load on the CPU 20 can be reduced, and the operation of the CPU 20 can be stopped during the control of the data transfer by the data transfer control unit 26. Hence, the power consumption of the electronic equipment, including the sound data processing apparatus 200, can be decreased.

Although the case where the external memory 102 is a detachably attachable memory card has been described in the embodiment of the present invention, the present invention is not limited to the case. For example, the external memory 102 may be an incorporation type memory chip mounted in electronic equipment, such as a compressed music reproducing apparatus, together with the sound data processing apparatus 200. In this case, the sound data processing apparatus 200 is preferably provided with an input-output interface for writing music data into the memory chip from an external computer. As the input-output interface, for example, a universal serial bus (USB) can be used.

Moreover, although an example wherein the sound data processing apparatus 200 is used for the reproduction of music has been described in the embodiment of the present invention, the present invention is not limited to such a case. For example, the functions of the sound data processing apparatus 200 can be diverted to the reproduction processing of compressed image data. Examples of usable formats for the compressed image data include the Moving Picture Expert Group (MPEG) (registered trademark) format, Windows Media Video (WMV) (registered trademark) format, and the like.

What is claimed is:

1. A sound data processing apparatus, comprising:
a decoder for performing decoding processing of sound data;
an interface unit connected to an external memory;
a data transfer control unit for reading the sound data from the external memory connected to the interface unit to transfer the read sound data to the decoder; and
a central processing unit for controlling processing of the decoder, the interface unit, and the data transfer control unit.

2. The sound data processing apparatus according to claim 1, wherein
the data transfer control unit performs control of transferring a predetermined amount of the sound data in response to an instruction of the central processing unit.

3. The sound data processing apparatus according to claim 1, wherein
the central processing unit stops an operation thereof during a period in which the data transfer control unit is operating after the central processing unit has output an instruction of transferring the sound data to the data transfer control unit.

4. The sound data processing apparatus according to claim 2, wherein
the central processing unit stops an operation thereof during a period in which the data transfer control unit is operating after the central processing unit has output an instruction of transferring the sound data to the data transfer control unit.
